(19) United States
(12) Patent Application Publication
(10) Pub. No.: US 2002/0016255 A1
(43) Pub. Date: Feb. 7, 2002

(54) Magnesium-zirconium alkoxide complexes and polymerization catalysts made therefrom

(76) Inventor: Robert Charles Job, Bound Brook, NJ (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/907,887

(22) Filed: Jul. 17, 2001

Related U.S. Application Data
(63) Continuation of application No. 09/395,916, filed on Sep. 14, 1999.
(60) Provisional application No. 60/141,666, filed on Jun. 30, 1999.

(51) Int. Cl. C08F 4/44

(52) U.S. Cl. 502/113; 502/117; 502/125; 502/126; 502/127; 526/113; 526/114; 526/118; 526/119; 526/125.3; 526/128

(57) ABSTRACT

A mixed metal-containing precursor is disclosed whereby the precursor includes: a) MgZrMₓ where M is selected from one or more metals having a +3 or +4 oxidation state, x is from 0 to about 2, and where the molar ratio of magnesium to the mixture of zirconium and M is within the range of from about 2.5 to 3.6; and b) at least one moiety complexed with component a) selected from the group consisting of alkoxide groups, phenoxide groups, halides, hydroxy groups, carboxylate groups, amide groups, and mixtures thereof A polymerization procatalyst prepared from the mixed metal containing precursor, methods of making the precursor and procatalyst, as well as polymerization methods using the procatalyst also are disclosed.

### BACKGROUND OF THE INVENTION

1. Field of the Invention

The present invention relates to mixed metal alkoxide complexes containing magnesium and zirconium useful as precursors for polymerization procatalysts that are ultimately useful in polymerizing α-olefins. The precursor complexes can be prepared by reacting a mixture of various metal alkoxides, halides or amides, including the respective magnesium and zirconium compounds, in the presence of a clipping agent to form a solid complex. The solid complex then can be used to form a procatalyst by contacting it with a halogenating, agent and optionally an electron donor. The procatalyst then can be converted to an olefin polymerization catalyst by contacting it with a cocatalyst and optionally a selectivity control agent

2. Description of Related Art

Recent titanium-based olefin polymerization catalysts are stereoregulating and have sufficient activity to avoid extraction and deashing. These high activity catalysts typically are prepared via chlorination of a magnesium containing precursor, in the presence of an electron donor compound, to form a solid procatalyst that usually contains magnesium, titanium and halide moieties, and comprises additionally a cocatalyst (usually an organoaluminum compound) and an optional selectivity control agent (SCA) for propylene polymerization. The magnesium containing complex is typically is referred to as a “precursor”, the solid titanium-containing compound typically is referred to as a “procatalyst”, the organoaluminum compound, whether complexed or not, usually is referred to as the “cocatalyst” and the third component external electron donor, whether used separately or partially or totally complexed with the organoaluminum compound, is referred to as the “selectivity control agent.” Throughout this disclosure, these terms will be used in accordance with the aforementioned designations. As before, if the shape of the catalyst particle and thus the shape of the resulting polymer particle is of importance, the catalyst precursor must be sufficiently robust so that it can withstand the rigors of the halogenation process.

Conventional titanium based catalysts suffer from the drawback that they typically are not capable of making polyolefins having a broad molecular weight distribution (MWD). High density film applications, however, require polyethylene and polypropylene copolymers which exhibit a very broad MWD. The requisite broad MWD usually can not be obtained by catalysts used in conventional low pressure, fluidized bed reactors. Thus, a solution has been to carry out polymerization in two consecutive reactors. In addition to being somewhat more costly than a single reactor process, the process of preparing two component polymers of radically different molecular weights at two different times (i.e. sequentially) can lead to serious problems with homogeneity of mixing.

It would be desirable to make broad molecular weight distribution polymers in a single reactor. The art recently has attempted to solve the aforementioned problems by using two different catalysts in a single reactor to produce a polyolefin product having a broad molecular weight distribution, or bimodal molecular weight distribution. These mixed, or hybrid, catalyst systems typically comprise a combination of a heterogeneous Ziegler-Natta catalyst and a homogenous metallocene catalyst. These mixed systems are used to prepare polyolefins having broad molecular weight distribution, and they provide a means to control the molecular weight distribution and polydispersity of the polyolefin.

There are myriad of documents disclosing mixtures of Ziegler-Natta type catalysts and metallocene catalysts to produce polyolefins having broad molecular weight distribution. For example, W.O Pat. 9513871, and U.S. Pat. No. 5,539,076 disclose a mixed metallocene/non-metallocene catalyst system to produce a specific bimodal, high density copolymer. The catalyst system disclosed therein is supported on an inorganic support, like silica, as a support. Other documents disclosing mixed Ziegler-Nattalmetallocene catalyst on a support (such as silica, alumina, magnesium-chloride and the like) include, W.O. Pat. No. 9802245, U.S. Pat. No. 5,183,867, E.P Pat. No. 0676418A1, U.S. Pat. No. 5,747,405, E.P. Pat. No. 0705848A2, U.S. Pat. No. 4,659,685, U.S. Pat. No. 5,395,810, E.P. Pat. No. 0747402A1, U.S. Pat. No. 5,266,544, and W.O. 9613532, the disclosures of which are incorporated herein by reference in their entirety.

Supported Ziegler-Natta and metallocene systems suffer from many drawbacks, one of which is an attendant loss of activity due to the bulky support material. Delivery of liquid, unsupported catalysts to a gas phase reactor was first described in Brady et al., U.S. Pat. No. 5,317,036, the disclosure of which is incorporated herein by reference in its entirety. Brady recognized disadvantages of supported catalysts including, inter alia, the presence of ash, or residual support material in the polymer which increases the impurity level of the polymer, and a deleterious effect on catalyst activity because not all of the available surface area of the catalyst comes into contact with the reactants. Brady further described a number of advantages attributable to delivering a catalyst to the gas phase reactor in liquid form. Brady did not appreciate, however, that a self-supporting Ziegler-Natta catalyst could be used to form a polyolefin in a single reactor having a broad molecular weight distribution.

There are other problems with the use of a mixture of two (or more) supported catalysts. In these systems, each catalyst produces a polymer having a target average molecular weight which differs significantly from that produced by the other of the catalysts. Producing polymer having different molecular weights from separate catalyst particles, however, severely limits mixing of polymers formed by such systems. Moreover, the supported catalysts usually suffer from poor morphology, which can cause problems when polymerization is carried out in the gas phase.

When the polymerization process takes place in the gas phase (e.g. in a fluidized bed reactor) or in slurry, it is desirable to obtain satisfactory granular particle morphology without having to resort to tedious steps such as spray drying or impregnation upon an inert support (e.g. silica). There are a number of documents describing modifying catalyst precursor, or procatalyst fabrication techniques to produce catalyst having satisfactory granular particle morphology. For example, U.S. Pat. No. 5,124,298, the disclosure of which is incorporated by reference herein in its entirety, teaches the production of well shaped (spheroidal) granular catalyst precursors by the precipitation methathesis reaction of solid magnesium ethoxide with TiCl₄ and Ti(OR)₄ in the presence of a small amount of an activated phenol clipping agent.

A number of United States patents issued to Robert C. Job (and Robert C. Job, et al.,) describe various mechanisms for preparing magnesium-containing, titanium-containing compounds that are useful as precursors for the production of procatalysts that are ultimately useful in preparing catalysts for the polymerization of α-olefins. For example, U.S. Pat. Nos. 5,034,361; 5,082,907; 5,151,399; 5,229,342; 5,106,806; 5,146,028; 5,066,737; 5,122,494, 5,124,298, and 5,077,357, the disclosures of which are incorporated by reference herein in their entirety, disclose various procatalyst precursors. U.S. Pat. No. 5,034,361 discloses solubilizing a magnesium alkoxide in an alkanol solvent by interaction of the magnesium alkoxide compound and certain acidic materials. This magnesium alkoxide then can be used either directly as a magnesium-containing catalyst precursor, or can be reacted with various titanium compounds to produce a magnesium and titanium-containing catalyst precursor.

U.S. Pat. Nos. 5,082,907; 5,151,399; 5,229,342; 5,106,806; 5,146,028; 5,066,737; 5,122,494, 5,124,298, and 5,077,357 disclose various magnesium and titanium-containing catalyst precursors, some of which are prepared by using the aforementioned magnesium alkoxide as a starting material. These precursors are not active polymerization catalysts, and they do not contain any effective amounts of electron donor. Rather, the precursors are used as starting materials in a subsequent conversion to an active procatalyst. Magnesium and titanium-containing procatalysts are forced by chlorinating the magnesium and titanium-containing precursor with a tetravalent titanium halide, an optional hydrocarbon and an optional electron donor. The resulting procatalyst solid then is separated from the reaction slurry (by filtration, precipitation, crystallization, and the like). These procatalysts then are converted to polymerization catalysts by reaction with, for example, an organoaluminum compound and a selectivity control agent.

While these magnesium and titanium-containing procatalysts are very effective in producing polyolefins, they are not as effective in producing polyolefins with unconventional properties. For example, these traditional Ziegler-Natta procatalysts typically are not used, either alone or in conjunction with other catalysts (i.e., metallocenes), to make polymers having a broad molecular weight distribution. The magnesium and titanium-containing procatalysts known in the art also are not prepared to have specifically tailored catalyst decay rates, which is a useful attribute in assuring homogeneous product composition over a range of reactor residence times, and also is a useful attribute when the catalyst is used in consecutive reactor polyolefin processes. In addition, these procatalysts are sensitive to esoteric, or unconventional comonomers, like dienes and the like, and they typically lose a substantial portion of their activity in the presence of such comonomers. Finally, conventional catalysts that contain mixed metals, while capable of making polymer having high molecular weight components, as well as broader molecular weight distribution, produce polymer which often is difficult to process and has poor flow characteristics (i.e., poor melt flow ratio and poor flow index).

### SUMMARY OF THE INVENTION

There exists a need to develop a single catalyst having good morphology that can be used to make polyolefins having a broad MWD. There also exists a need to develop a catalyst that can produce polyolefins having a broad MWD in a single reactor. There also exists a need to provide a method of making a substantially spheroidal procatalyst having controlled catalyst decay rates, and a method of making a substantially spheroidal procatalyst capable of making polymer particles having broad MWD. A need also exists to develop a catalyst precursor and method of making the catalyst that does not suffer from any of the aforementioned disadvantages.

In accordance with these and other features of the invention, there is provided a mixed metal complex precursor containing, as the mixed metal portion, Mg_{y}ZrMₓ where M is selected from one or more metals having a +3 or +4 oxidation state, where x is from 0 to about 2, and where the molar ratio of magnesium to the mixture of zirconium and M (i.e. y/(1+x)) is within the range of from about 2.5 to 3.6. The precursor also has, complexed to the mixed metal portion, at least one group selected from alkoxide groups, phenoxide groups, halides, hydroxy groups, carboxylate groups and amide groups. The invention also provides a method of making the precursor comprising contacting a mixture of a magnesium alkoxide, halide, carboxylate, amide, phenoxide or hydroxide with a zirconium alkoxide, halide, carboxylate, amide, phenoxide or hydroxide to form a solid precursor complex, and then separating the solid complex from the mixture. In accordance with this method, a clipping agent preferably is used and, optionally, a halide and an aliphatic alcohol can be used to form the solid precursor complex.

In accordance with another feature of the invention, there is provided a procatalyst prepared by reacting the above-mentioned precursor with an appropriate halogenating agent, and optional electron donor, where the procatalyst, when converted to a catalyst and used to polymerize at least one olefin, has improved catalytic activity and yields polymer having a broad MWD, excellent bulk density, melt index, flow index and melt flow rate. In addition, the catalyst has a controlled catalyst decay rate.

The invention also provides a high activity olefin polymerization procatalyst that comprises: (i) the procatalyst precursor comprising the mixed metal portion as described above; (ii) an electron donor; (iii) a halide; and (iv) optionally, a hydrocarbon. The invention additionally provides a high activity olefin polymerization catalyst that comprises: (i) the above-described procatalyst; (ii) an organoaluminum cocatalyst; and (iii) an optional selectivity control agent. The invention also provides methods of making each of the above-described precursors, procatalysts and catalysts. In addition, the invention provides methods of polymerizing olefins (homopolymers, copolymers, terpolymers, etc.) by contacting an olefin monomer (or monomers) with the above-described high activity olefin polymerization catalyst.

These and other features of the present invention will be readily apparent to those skilled in the art upon reading the detailed description that follows.

### DESCRIPTION OF PREFERRED EMBODIMENTS

Throughout this description, the expression “clipping agent” denotes a species that is capable of assisting in the breakup of a polymeric magnesium alkoxide. Specifically, clipping agents include: (i) those species which, in large excess are capable of dissolving magnesium alkoxides; (ii) large anions; and (iii) those that prevent magnesium alkoxides from polymerizing.

Throughout this description the term “precursor” and the expression “procatalyst precursor” denotes a solid material that contains a mixture of magnesium, zirconium and M metals, (keeping in mind that M can comprise more than one metal), but does not contain an electron donor, and which can be converted to a “procatalyst” (defined below) by contacting it with a halogenating agent such as alkylaluminum halide or tetravalent titanium halide, and optionally an electron donor. Throughout this description, the term “procatalyst” denotes a solid material that is an active catalyst component, and that can be converted to a polymerization catalyst by contact with an organoaluminum compound (preferably triisobutyl aluminum (TIBA) and aluminoxane), and an optional external donor, or selectivity control agent.

The present invention relates to a mixed metal alkoxide complex precursor containing, as the mixed metal portion, Mg_{y}ZrMₓ where M is selected from one or more metals having a +3 or +4 oxidation state, x is from 0 to about 2, and the molar ratio of magnesium to the mixture of zirconium and M (y/(1+x)) is within the range of from about 2.5 to 3.6. The precursor also has, complexed to the mixed metal portion, at least one group selected from alkoxide groups, phenoxide groups, halides, hydroxy groups, carboxylate groups and amide groups.

It is preferred in the present invention that M is one or more metal selected from the group consisting of Ti, Zr, V, Fe, Sn, Ni, Rh, Co, Cr, Mo, W, and Hf. Most preferably, M is Ti or Zr. The molar ratio of the M metal to the magnesium preferably is within the range of from 0 to about 2, more preferably within the range of from about 0.01 to about 0.5, and most preferably, the molar ratio is from about 0.1 to about 0.3. The molar ratio of the Mg to the combination of Zr and M preferably is within the range of from about 2.5 to about 3.6, more preferably within the range of from about 2.75 to about 3.25, and most preferably 3.

The mixed metal alkoxide precursor also has, complexed to the mixed metal portion, at least one group selected from alkoxide groups, phenoxide groups, halides, hydroxy groups, carboxylate groups and amide groups. Preferably, alkoxide groups and halide groups are complexed to the mixed metal portion to form the mixed metal alkoxide precursor of the present invention.

The mixed metal alkoxide precursor can be made by any method capable of forming a complex between the mixture of metals, and the additional complexing groups, at least one of which is selected from alkoxide groups, phenoxide groups, halides, hydroxy groups, carboxylate groups and amide groups. Preferably, the precursor is prepared by contacting a mixture of magnesium alkoxide, halide, carboxylate, amide, phenoxide or hydroxide with a mixture of zirconium alkoxide, halide, carboxylate, amide, phenoxide or hydroxide, and optionally a metal M alkoxide, halide, carboxylate, amide, phenoxide or hydroxide to form a solid precursor complex, and then separating the solid complex from the mixture. In accordance with this method, a clipping agent preferably is used and, optionally, an aliphatic alcohol can be used to form the solid precursor complex. In addition, a halide can be used during the preparation of the mixed metal alkoxide precursor complex, preferably a chloride, and most preferably, ZrCl_{4.}

A particularly preferred method of making the mixed metal alkoxide precursor of the invention is shown in the table below.

| | |
|---|---|
| {aMg(OR)₂ + bMgCl₂ + | a + b + c = 2.5 to 3.75 |
| cM_{g}XₚY_{q} +} | R, R′, R″ are alkyl having 1 to 10 carbon |
| | atoms or mixture |
| | X = halide or alkoxide |
| | Y = halide or alkoxide or clipper anion |
| {dZr(OR′)₄ + eZrCl₄ + | M = +3 or +4 metal |
| fZrZ₄ | 0.4 < d + e + f + u + v + w < 2 |
| uM(OR′)₄ + vMCl₄ + | 0.8 < d + e + f + u + v + w < 1.2 is preferred |
| wMZ₄} + | Z = halide, alkoxide, amide or mixture |
| gClipping agent + | 0 < g ≦ 2, if Y is clipper then 0 < g + cq < 2 |
| | 0.1 < g < 0.4 is preferred |
| hR″OH | R″OH is a single alcohol or a mixture |
| | 0.5 < h < 8 |

Any clipping agent that is capable of carrying out the functions described above can be used in the present invention. Clipping agents useful in the present invention include species which in large amounts will dissolve the magnesium alkoxide, large anions, and species that prevent the magnesium alkoxide from polymerizing. Preferably, the clipping agents are selected from cresol, 3-methoxyphenol, 4-dimethylaminophenol, methyl salicylate or p-chlorophenol, HCHO, CO₂, B(OEt)₃, SO₂, Al(OEt)₃,CO₃₌,Br^{-, (O}₂COEt)⁻, Si(OR)₄, R'Si(OR)₃, and P(OR)₃. In the above compounds, R and R' represent hydrocarbon groups, preferably alkyl groups, containing from 1-10 carbon atoms, and preferably R and R' are the same or different and are methyl or ethyl. Other agents that release large anions or form large anions in situ (i.e., clipping agent precursors) can be used, such as MgBr_{2,} carbonized magnesium ethoxide (magnesium ethyl carbonate), calcium carbonate, and the like. Thus, the expression “clipper anion” mentioned in the table above denotes these anions.

The clipping agent preferably is used in an amount less than that required to fully dissolve the magnesium alkoxide. Preferably, the clipping agent is used in an amount ranging from 0 (if a clipping agent precursor is used) to 0.67 moles of clipping agent for every mole of magnesium. More preferably, the clipping agent is used in an amount ranging from about 0.01 moles to about 0.3 moles, and most preferably, from about 0.03 moles to about 0.15 moles per mole of magnesium.

Any alcohol or mixtures of alcohols can be used to prepare the mixed metal alkoxide complex precursor. Preferably, the alcohol is an aliphatic alcohol, and more preferably, the alcohol is selected from methanol, ethanol, butanol, propanol, i-propyl alcohol, n-butyl alcohol, n-propyl alcohol, and mixtures thereof Most preferably the alcohol is ethanol, butanol, and mixtures thereof

The mixed metal alkoxide complex precursor can be produced by any of the methods described in U.S. Pat. Nos. 5,122,494, 5,124,298, and 5,371,157, the disclosures of which are incorporated by reference herein in their entirety, including the modification of substituting the titanium tetraalkoxide with a suitable zirconium compound, as well as using a variety of metal (M) compounds (i.e., halides, alkoxides, amides, etc. of M). The complex mixed metal-containing alkoxide compound preferably can be produced by reacting magnesium alkoxide, zirconium alkoxide, an optional halide selected from TiCl₃, TiCl₄, ZrCl₄, VC1₄, FeCl₃, SnCl₄, HfCl₄, MnCl₂, Mg(FeCl₄)₂, and SmCl₃, and an optional phenolic compound in the presence of an inert reaction diluent. The diluent then can be removed (by decantation or filtration or other suitable means) to produce, as a particulate solid, the complex alkoxide compound. This solid then can be treated with a halogenating agent to produce an olefin polymerization procatalyst, which then can be used, in the optional presence of selectivity control agent, to promote the polymerization of lower α-olefins by polymerization techniques which are largely conventional.

The alkoxide moieties of the magnesium alkoxides are the same as or are different from the alkoxide moieties of the zirconium alkoxides, it being understood that not all the magnesium and/or zirconium metals are in the form of an alkoxide. Moreover, the alkoxide moieties of one metal alkoxide reactant can be the same as or different from the alkoxide moieties of the other metal alkoxide reactant. In part for reasons of complex alkoxide purity, it is preferred that all alkoxide moieties of the mixed metal alkoxides be the same. The preferred alkoxide moieties are methoxide or ethoxide (R and R' above are methyl or ethyl) and particularly preferred is ethoxide. Magnesium ethoxide, titanium tetraethoxide, zirconium tetraethoxide, and hafnium tetraethoxide are the preferred metal alkoxide reactants for the production of the mixed metal alkoxide complex.

If a phenolic compound is used to form the mixed metal alkoxide precursor, the phenolic compound preferably is selected from phenol or an activated phenol. By the term “activated phenol” is meant a monohydroxylic phenol of one aromatic ring having aromatic ring substituents other than hydrogen which serve to alter the pKa of the phenolic compound. Such substituent groups are free from active hydrogen atoms and include halogen, e.g., chlorine or bromine, alkyl and particularly alkyl of up to 4 carbon atoms inclusive, and dialkylamino wherein each alkyl has up to 4 carbon atoms inclusive. Suitable substituent groups do not include hydroxy. Illustrative of suitable phenolic compounds are phenol, p-cresol, o-cresol, 3-methoxyphenol, 2,6-di-t-butyl-4-methylphenol (BHT), 2,4-diethylphenol, p-chlorophenol, p-bromophenol, 2,4-dichlorophenol, p-dimethylaminophenol, methyl salicylate and m-diethylaminophenol.

The mixed metal alkoxide can have, complexed with the magnesium and Zirconium, an additional metal M selected from Ti, Zr, V, Fe, Sn, Ni, Rh, Co, Cr, Mo, W, and Hf. In the aforementioned reaction, if an additional metal is used, the metal (M) compounds preferably are selected from the group consisting of VCl₄, FeCl₃, SnCl₄, Ti(OEt)₄, TiCl₃, TiCl₄, HfCl₄, Hf(OEt)₄, , Zr(NEt₂)₄ .Skilled artisans are capable of utilizing any of these metal containing compounds to prepare a mixed metal alkoxide including M, using the guidelines provided herein.

The contacting of the mixed metal compounds, clipping agent (or clipper), optional halide, optional phenolic compound, and optional alcohol preferably takes place at an elevated temperature in an inert reaction diluent. The reaction diluent is one in which all reactants are at least partially soluble and which does not react with the reactants or the complex alkoxide product. Preferred reaction diluents are hydrocarbon such as isooctane, isopentane or n-heptane, or are halohydrocarbon such as methylene chloride, carbon tetrachloride or chlorobenzene. The contacting preferably takes place at a reaction temperature from about 50° C. to about 120° C. Contacting typically is effected in a suitable reactor and is facilitated by conventional procedures such as shaking, stirring or refluxing. The phenolic compound, if used, preferably is provided in a quantity of from about 0.02 mole to about 2 moles per mole of mixture of zirconium and M (e.g., zirconium tetraalkoxide, zirconium tetrachloride, vanadium tetrachloride and the like), but preferably in a quantity of from about 0.1 mole to about 0.5 moles per mole of mixture of zirconium and M metals. The magnesium compounds can be provided in a quantity from about 1.5 mole to about 8 moles per mole of mixture of zirconium and M metals. Preferred quantities of magnesium compounds are from about 2.7 moles to about 3.5 moles per mole of mixture of zirconium and M metals.

Upon contacting all of the components, the mixture then can be heated to anywhere from about 50° C. to about 120° C. by any suitable heating apparatus. The components are mixed at this elevated temperature for about 5 minutes to about 9 hours, preferably, from about 25 minutes to 7 hours, and most preferably from about 45 minutes to 2 hours; such time to be determined by visual evidence such as the consumption of original solid reactants. Those skilled in the art are capable of determining when the original mixed metal reactants have disappeared and/or when a homogeneous slurry has been formed, using the guidelines provided herein.

Upon forming the homogeneous slurry, the alcohol then is preferably removed from the solution by heating the solution at temperatures above 100° C., and/or passing nitrogen over the solution. Removal of alcohol enables the precipitation of additional mixed metal alkoxide complex which may remain dissolved in solution (i.e., solid precursor material) and results in enhanced yield of product. The solid complex then can be removed from the reaction mixture by conventional means.

Preferably, the solid precursor materials are separated from the reaction mixture by any suitable means, including but not limited to, decantation, filtration, centrifugation, and the like. More preferably, the solid material is filtered, most preferably under the impetus of pressure and/or temperature. The filtered solids then can be washed at least once with one or more solvents, including but not limited to monochlorobenzene, toluene, xylene, isopentane, isooctane, and the like. After separation from the mixture, (or mother liquor, and subsequent wash solvents), the solid procatalyst precursor preferably is dried. Drying typically is conducted by supplying dry, moisture-free inlet nitrogen at a temperature of about 25° C. to about 45° C. for anywhere from about 10 minutes to about 10 hours thereby resulting in a product that is substantially dry. Higher temperatures on the order of 50 to about 150° C. can be used to dry the precursor in shorter periods of time.

Any mechanism can be used to carry out the drying of the present invention. For example, the filter cake could be dried by flowing a heated inert gas stream through the cake for the time period described above. Alternatively, the filter cake could be removed from the filter and then subsequently dried in a conventional drying apparatus using direct, indirect, infrared, radiant or dielectric heat. Any apparatus capable of drying solids at temperatures above about 25° can be used in accordance with the present invention. Particularly preferred drying apparatus include, but are not limited to, direct continuous dryers, continuous sheeting dryers, pneumatic conveying dryers, rotary dryers, spray dryers, through-circulation dryers, tunnel dryers, fluid bed dryers, batch through-circulation dryers, tray and compartment dryers, cylinder dryers, screw-conveyor dryers, drum dryers, steam-tube rotary dryers, vibrating-tray dryers, agitated pan dryers, freeze dryers, vacuum rotary dryers and vacuum-tray dryers. Most preferably, the solid precursor material is dried in a single or multiple-leaf combined filter and dryer. Those skilled in the art are capable of designing a suitable dryer and drying protocol to effect drying the precursor in accordance with the present invention.

The precursor of the present invention then can be immediately converted to a procatalyst by any suitable means known to the art described below, or it can be stored for later use or for shipment to a facility capable of converting the precursor to a procatalyst. Upon drying, the solid precursor material can be discharged by any suitable means to downstream processing.

Conversion of the dried procatalyst precursor to a procatalyst can be accomplished in any suitable manner. For example, the dried precursors of the invention can be converted to polymerization procatalyst by reaction with a halide, like tetravalent titanium halide, an optional hydrocarbon or halohydrocarbon and an electron donor. The tetravalent titanium halide is suitably an aryloxy- or alkoxy di- or trihalide such as diethoxytitanium dichloride, dihexyloxytitanium dibromide or diisopropoxytitaniumchloride or the tetravalent titanium halide is a titanium tetrahalide such as titanium tetrachloride or titanium tetrabromide. A titanium tetrahalide is preferred as the tetravalent titanium halide and particularly preferred is titanium tetrachloride. Halogenation also can be carried out by any of several means known to the art. These include but are not limited to treatment of the precursor with SiCl₄, RₓAlCl₃₋, BCl₃ and the like. Suitable procatalyst preparation procedures are described in the aforementioned U.S. Pat. No. 5,124,298 and U.S. Pat. No. 5,132,263.

Any electron donor can be used in the present invention so long as it is capable of converting the precursor into a procatalyst. Suitable electron donors are those electron donors free from active hydrogen that are conventionally employed in the formation of titanium-based procatalysts. Particularly preferred electron donors include ethers, esters, amines, imines, nitriles, phosphines, stibines, dialkyoxy benzenes, and arsines. The more preferred electron donors, however, include esters and ethers, particularly alkyl esters of aromatic monocarboxylic or dicarboxylic acids and particularly aliphatic gr cyclic ethers. Examples of such electron donors are methyl benzoate, ethyl benzoate, ethyl p-ethoxybenzoate, 1,2-dialkyoxy benzenes, ethyl p-methylbenzoate, diethyl phthalate, dimethyl naphthalene dicarboxylate, diisobutyl phthalate, diisopropyl terephthalate, diethyl ether and tetrahydrofuran. The electron donor is a single compound or is a mixture of compounds but preferably the electron donor is a single compound. Of the preferred electron donors, ethyl benzoate, 1,2-dialkoxy benzenes and diisobutyl phthalate are particularly preferred.

In a preferred embodiment, the mixture of procatalyst precursor, halide, electron donor and halohydrocarbon is maintained at an elevated temperature, for example, a temperature of up to about 150° C. Best results are obtained if the materials are contacted initially at or about ambient temperature and then heated. Sufficient halide is provided to convert at least a portion and preferably at least a substantial portion of the alkoxide moieties of the procatalyst precursor to halide groups. This replacement is conducted in one or more contacting operations, each of which is conducted over a period of time ranging from a few minutes to a few hours and it is preferred to have halohydrocarbon present during each contacting. Sufficient electron donor usually is provided so that the molar ratio of electron donor to the mixed metals (magnesium, zirconium and M) present in the solid procatalyst is from about 0.01:1 to about 1:1, preferably from about 0.05:1 to about 0.5:1. The final washing with light hydrocarbon produces a procatalyst that is solid and granular and when dried is storage stable provided that oxygen and active hydrogen compounds are excluded. Alternatively, the procatalyst is used as obtained from the hydrocarbon washing without the need for drying. The procatalyst thus produced is employed in the production of an olefin polymerization catalyst by contacting the procatalyst with a cocatalyst and optionally a selectivity control agent.

The mixed metal-containing procatalyst serves as one component of a Ziegler-Natta catalyst system where it is contacted with a cocatalyst and optionally, a selectivity control agent. The cocatalyst component employed in the Ziegler-Natta catalyst system may be chosen from any of the known activators of olefin polymerization catalyst systems employing a transition metal halide, but organoaluminum compounds are preferred. Illustrative organoaluminum cocatalysts include trialkylaluminum compounds, alkyaluminum alkoxide compounds alkylaluminoxane compounds and alkylaluminum halide compounds in which each alkyl independently has from 2 to 6 carbon atoms inclusive. The preferred organoaluminum cocatalysts are halide free and particularly preferred are the trialkylaluminum compounds. Such suitable organoaluminum cocatalysts include compounds having the formula Al(R^{′″})_{d}XₑH_{f} wherein: X is F, Cl, Br, I or OR″″, R′″ and R″″ are saturated hydrocarbon radicals containing from 1 to 14 carbon atoms, which radicals may be the same or different, and, if desired, substituted with any substituent which is inert under the reaction conditions employed during polymerization, d is 1 to 3, e is 0 to 2, f is 0 or 1, and d+e+f=3. Such cocatalysts can be employed individually or in combination thereof and include compounds such as Al(C₂H₅)₃, Al(C₂H₅)₂Cl, Al₂(C₂H₅)₃Cl₃, Al(C₂H₅)₂H, Al(C₂H₅)₂(OC₂H₅ ) ,Al(i-C₄H₉)₃,Al(i-C₄H₉)₂H,Al(C₆H₁₃)₃ and Al(C₈H₁₇)₃.

Preferred organoaluminum cocatalysts are triethylaluminum, triisopropyl aluminum, triisobutyl aluminum and diethylhexyl aluminum. Triisobutyl aluminum is a preferred trialkyl aluminum cocatalyst.

The organoaluminum cocatalyst also can be an aluminoxane such as methylaluminoxane (MAO) or modified methylaluminoxane (MMAO), or a boron alkyl. The method of preparing aluminoxanes is well known in the art. Aluminoxanes may be in the form of oligomeric linear alkyl aluminoxanes represented by the formula:

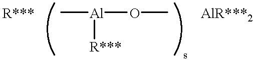

or oligomeric cyclic alkyl aluminoxanes of the formula:

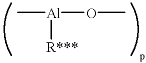

wherein s is 1-40, preferably 10-20; p is 3-40, preferably 3-20; and R^{***} is an alkyl group containing 1 to 12 carbon atoms, preferably methyl or an aryl radical such as a substituted or unsubstituted phenyl or naphthyl radical. In the case of MAO, R^{***} is methyl, whereas in MMAO, R^{***} is a mixture of methyl and C2 to C12 alkyl groups wherein methyl comprises about 20 to 80 percent by weight of the R^{***} group.

The organoaluminum cocatalyst, during formation of the olefin polymerization catalyst, is preferably employed in a molar ratio of aluminum to the mixture of zirconium and M of the procatalyst of from about 1:1 to about 500:1, but more preferably in a molar ratio of from about 10:1 to about 150:1.

The final component of the Ziegler-Natta catalyst system is the optional selectivity control agent (SCA), or external electron donor, which typically is used when polymerizing propylene, or mixtures thereof. Typical SCAs are those conventionally employed in conjunction with titanium-based procatalysts and organoaluminum cocatalysts. Illustrative of suitable selectivity control agents are those classes of electron donors employed in procatalyst production as described above as well as organosilane compounds including alkylakoxysilanes and arylalkoxysilanes. Particularly suitable silicon compounds of the invention contain at least one silicon-oxygen-carbon linkage. Suitable silicon compounds include those having the formula R¹ ₘSiYₙXₚ wherein: R¹ is a hydrocarbon radical containing from 4 to 20 carbon atoms, Y is -OR² or -OCOR² wherein R² is a hydrocarbon radical containing from 1 to 20 carbon atoms, X is hydrogen or halogen, m is an integer having a value of from 0 to 3, n is an integer having a value of from 1 to 4, p is an integer having a value of from 0 to 1, and preferably 0, and m+n+p=4. RI should be such that there is at least one non-primary carbon in the alkyl and preferably, that such non-primary carbon is attached directly to the silicon atom. Examples of R¹ include cyclopentyl, t-butyl, isopropyl or cyclohexyl. Examples of R² include ethyl, butyl, isopropyl, phenyl, benzyl and t-butyl. Examples of X are Cl and H.

Each R¹ and R² may be the same or different, and, if desired, substituted with any substituent which is inert under the reaction conditions employed during polymerization. Preferably, R² contains from 1 to 10 carbon atoms when it is aliphatic and may be sterically hindered or cycloaliphatic, and from 6 to 10 carbon atoms when it is aromatic. Silicon compounds in which two or more silicon atoms are linked to each other by an oxygen atom, i.e., siloxanes or polysiloxanes, may also be employed, provided the requisite silicon-oxygen-carbon linkage is also present. The preferred selectivity control agents are alkylalkoxysilanes such as ethyltriethoxysilane, diisobutyl dimethoxysilane, cyclohexylmethyldimethoxysilane, propyl trimethoxysilane, dicyclohexyl dimethoxysilane, and dicyclopentyl dimethoxysilane. In one modification, the selectivity control agent is a portion of the electron donor added during procatalyst production. In an alternate modification the selectivity control agent is provided at the time of the contacting of procatalyst and cocatalyst. In either modification, the selectivity control agent is provided in a quantity of from 0.1 mole to about 100 moles per mole of mixture of Zr and M in the procatalyst. Preferred quantities of selectivity control agent are from about 0.5 mole to about 25 mole per mole of mixture of Zr and M in the procatalyst.

The olefin polymerization catalyst may be used in slurry, liquid phase, gas phase and liquid monomer-type reaction systems as are known in the art for polymerizing olefins. Polymerization preferably is conducted in a fluidized bed polymerization reactor, however, by continuously contacting an alpha-olefin having 2 to 8 carbon atoms with the components of the catalyst system, i.e, the solid procatalyst component, cocatalyst and optional SCAs. In accordance with the process, discrete portions of the catalyst components can be continually fed to the reactor in catalytically effective amounts together with the alpha-olefin while the polymer product is continually removed during the continuous process. Fluidized bed reactors suitable for continuously polymerizing alpha-olefins have been previously described and are well known in the art. Fluidized bed reactors useful for this purpose are described, e.g., in U.S. Pat. Nos. 4,302,565, 4,302,566 and 4,303,771, the disclosures of which are incorporated herein by reference. Those skilled in the art are capable of carrying out a fluidized bed polymerization reaction using the guidelines provided herein.

It is preferred sometimes that such fluidized beds are operated using a recycle stream of unreacted monomer from the fluidized bed reactor. In this context, it is preferred to condense at least a portion of the recycle stream. Alternatively, condensation may be induced with a liquid solvent. This is known in the art as operating in “condensing mode.” Operating a fluidized bed reactor in condensing mode generally is known in the art and described in, for example, U.S. Pat. Nos. 4,543,399 and 4,588,790, the disclosures of which are incorporated by reference herein in their entirety. The use of condensing mode has been found to lower the amount of xylene solubles in isotactic polypropylene and improve catalyst performance when using the catalyst of the present invention.

The catalyst composition may be used for the polymerization of olefins by any suspension, solution, slurry, or gas phase process, using known equipment and reaction conditions, and is not limited to any specific type of reaction system. Generally, olefin polymerization temperatures range from about 0° C. to about 200° C. at atmospheric, subatmospheric, or superatmospheric pressures. Slurry or solution polymerization processes may utilize subatmospheric or superatmospheric pressures and temperatures in the range of about 40° C. to about 110° C. A useful liquid phase polymerization reaction system is described in U.S. Pat. No. 3,324,095. Liquid phase reaction systems generally comprise a reactor vessel to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Preferably, gas phase polymerization is employed, with superatmospheric pressures in the range of 1 to 1000, preferably 50 to 400 psi, most preferably 100 to 300 psi, and temperatures in the range of 30 to 130° C., preferably 65 to 110° C. Stirred or fluidized bed gas phase reaction systems are particularly useful. Generally, a conventional gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally fully or partially condensed as disclosed in U.S. Pat. Nos. 4,528,790 and 5,462,999, and recycled to the reactor. Product is withdrawn from the reactor and make-up monomer is added to the recycle stream. As desired for temperature control of the system, any gas inert to the catalyst composition and reactants may also be present in the gas stream. In addition, a fluidization aid such as carbon black, silica, clay, or talc may be used, as disclosed in U.S. Pat. No. 4,994,534.

Polymerization may be carried out in a single reactor or in two or more reactors in series, and is conducted substantially in the absence of catalyst poisons. Organometallic compounds may be employed as scavenging agents for poisons to increase the catalyst activity. Examples of scavenging agents are metal alkyls, preferably aluminum alkyls, most preferably triisobutylaluminum.

The precise procedures and conditions of the polymerization are broadly conventional but the olefin polymerization process, by virtue of the use therein of the polymerization catalyst formed from the solid precursor, provides polyolefin product having a relatively high bulk density in quantities that reflect the relatively high productivity of the olefin polymerization catalyst. In addition, the polymeric products produced in the present invention have a reduced level of fines.

Conventional additives may be included in the process, provided they do not interfere with the operation of the catalyst composition in forming the desired polyolefin.

When hydrogen is used as a chain transfer agent in the process, it is used in amounts varying between about 0.001 to about 10 moles of hydrogen per mole of total monomer feed. Also, as desired for temperature control of the system, any gas inert to the catalyst composition and reactants can also be present in the gas stream.

The polymerization product of the present invention can be any product, homopolymer, copolymer, terpolymer, and the like. Usually, the polymerization product is a homopolymer such as polyethylene or polypropylene, particularly polypropylene. Alternatively, the catalyst and process of the invention are useful in the production of copolymers including copolymers of ethylene and propylene such as EPR and polypropylene impact copolymers when two or more olefin monomers are supplied to the polymerization process. Those skilled in the art are capable of carrying out suitable polymerization of homopolymers, copolymers, terpolymers, etc., using liquid, slurry or gas phase reaction conditions, using the guidelines provided herein.

Ethylene polymers of the invention include ethylene homopolymers, and interpolymers of ethylene and linear or branched higher alpha-olefins containing 3 to about 20 carbon atoms, with densities ranging from about 0.90 to about 0.95 and melt indices of about 0.005 to 1000. Suitable higher alpha-olefins include, for example, propylene, 1-butene, 1-pentene, 1-hexene, 4-methyl-i-pentene, 1-octene, and 3, 5, 5-trimethyl 1-hexene. Cyclic olefins such as vinyl cyclohexane or norbornene may also be polymerized with the ethylene. Aromatic compounds having vinyl unsaturation, such as styrene and substituted styrenes, may also be included as comonomers. Particularly preferred ethylene polymers comprise ethylene and about 1 to about 40 percent by weight of one or more comonomers described above.

The invention will now be illustrated by examples exemplifying particularly preferred embodiments thereof. Those skilled in the art will appreciate that these examples do not limit the invention but rather serve to more fully describe particularly preferred embodiments.

### EXAMPLES

In the examples, the following terms are defined as follows:

### GLOSSARY

MI is the melt index (optionally termed I₂), reported as grams per 10 minutes, determined in accordance with ASTM D-1238, condition E, at 190° C.

FI is the flow index (optionally termed I₂₁), reported as grams per 10 minutes, determined in accordance with ASTM D-1238 condition F, and was measured at ten times the weight used in the melt index test.

MFR is the melt flow ratio, which is the ratio of flow index to melt index. It is related to the molecular weight distribution of the polymer. For purposes of comparison, the relative narrow MWD polymer produced by many conventional polymerization catalysts exhibits MFR about 30 - 35. Where relevent, the polydispersity index Mw/Mn was determined by size exclusion chromatography (SEC).

For high molecular weight polymers an optional melt index is taken using the same conditions except using a 5.0 Kg weight. The melt index under that condition is termed I₅ and the melt flow ratio I₂₁/I₅ is termed MFR₅. As above, larger values of MFR₅ imply broader molecular weight distribution. For purposes of comparison, the relative narrow MWD polymer produced by many conventional polymerization catalysts exhibits MFR₅ about 9 - 11.

Productivity is given in Kg polymer/g procatalyst/hour/100 psi ethylene.

### Example 1

### Preparation of Mg and Zr-containing precursor

A magnesium and zirconium-containing precursor was prepared via the following reaction:

3 Mg(OEt)₂+0.55ZrCl₄+0.40Zr(OBu)₄+0.15Zr(OEt)₄+0.05HOC₆H₄CO₂OMe+4.8EtOH∵

A. About 32.0 grams of ZrCl₄ (138 mmol), Zr(OEt)₄ (10.2 g, 37.5 mmol) and Zr(OBu)₄ (44.0 g, 87.5%, 100 mmol) were mixed with 71 ml of Ethanol (55.5 g, 1.2 mol) in a quart bottle. Methyl salicylate (1.9 g, 12.5 mmol) then was added and the mixture stirred overnight at room temperature (solution gets warm) to obtain a yellow to dark-brown solution (solids were totally dissolved). The solution was diluted with 660 g of chlorobenzene. The bottle was given a quick purge of nitrogen, capped tightly and placed in a heating silicone fluid (PDMS, 20cs) bath, which has reached 75° C., and stirred at 440rpm. When the material temperature reached 95° C., Mg(OEt)₂ (85.8 g, 750 mmol) was added. After 3 hours at 95° all of the magnesium ethoxide granules appeared to have dissolved to produce a homogeneous translucent slurry. A gentle nitrogen flow was started and continued for about 4 hours (until 10-15% of the solvent has evaporated). Heating was then terminated and the reaction mixture was allowed to stir and cool overnight.

The mixture was transferred to a glovebox and filtered using a 600 ml medium frit and a 1 liter vacuum flask. The bottle was rinsed with 200 ml of chlorobenzene which was then used to wash the solids. The solids were then washed 3 times with 250 ml of hexane and sucked dry to produce 94.2 grams of white powder composed of 6-20 μm elongated, translucent granules. Scanning electron micrograph (SEM) revealed the granules to be composed of long, needle-like platelets. Analysis of the solid revealed that it contained about 13.9% Zr, and 13.3% Mg. The solid precursor was designated sample 1A.

B. The reaction in example 1A was repeated except that the oil bath was set at 75°, the magnesium ethoxide was added when the pot temperature had reached 65 ° and reaction was carried out for three hours at 75°. The yield was 88.4 g of dense white powder composed of 12-24 μm translucent granules. SEM analysis revealed the granules to be composed of short, wide platelets. Analysis of the solid material revealed that it contained about 13.9% Zr, and 13.5% Mg. The solid precursor was designated sample 1B.

Preparation of Polymerization Procatalyst

The magnesium and zirconium containing precursor of Example 1, sample 1A, (20.27 g) was slurried in 50 ml of toluene. The slurry was placed in a 75° oil bath to stir as 110 ml of 25% EADC/toluene was added over about 4 minutes. The slurry slowly turned to beige. After stirring for 45 minutes, the mixture was filtered. The solids were washed twice with hexane and dried under moving nitrogen to yield 19.82 g of off white powder. The powder was slurried again in 50 ml of toluene and returned to the 75° oil bath. Over a period of about three minutes, 110 ml of 25% EADC/toluene were added to produce a light gray slurry. After stirring for 45 minutes the mixture was filtered and the solids washed three times with hexane then dried under moving nitrogen. The yield was 16.433 g of grayish-white powder. Analysis of the powder revealed that it contained approximately 9.3% Zr, 10.3% Mg, and 5.3% Al. The sample was designated catalyst 1A

### Polymerization

To a one liter stainless steel reactor, containing 500 ml of hexane and 15 ml of 1-hexene, were added 1145 standard cubic centimeter of H₂ (42 psi partial pressure). Triisobutylaluminum (1.038 mmol of 0.865 M heptane solution) was injected by syringe. Catalyst 1A (0.104 g) was injected from a 50 ml bomb using ethylene pressure and about 20 ml of hexane. After polymerizing for 30 minutes at 85°, while adding ethylene on demand to keep the total pressure at 158 psi, the reaction was extinguished by injecting 2 ml of isopropanol. The catalyst decay rate had been 27%/20 minutes. The collected polymer was allowed to air dry overnight before characterization. The polymerization resulted in 120 g of polymer having a bulk density of 0.38 g/cc, a flow index (I₂₁) of 1.47 dg/min and I₅ of 0.050 dg/min (I₂₁/I₅ =29). SEC showed Mw/Mn to be 31.4.

### Example 2

### Preparation of polymerization procatalyst

A procatalyst containing Zr and Ti was prepared by addition of titanium to the magnesium and zirconium catalyst precursor prepared in accordance with example 1 above.

A. About 1.63 g of sample 1B was slurried in 4.5 ml of toluene then 2.0 ml of 3% TiCl₄/toluene solution was added dropwise. After shaking for an hour at room temperature, the brown slurry was filtered. The solids were washed once with toluene then four times with hexane and dried under moving nitrogen. The yield was 1.43 g of tan powder. Analysis of the powder revealed the presence of about 0.48% Ti, 11.0% Zr, 12.2% Mg, and 3.98% Al. A slurry of 0.300 g of catalyst in 20 ml of Kaydol oil was prepared for polymerization testing.

B. The procedure of Example 2A was repeated, using instead 1.5 ml of 3% TiCl₄/toluene, to obtain 1.43 g of light tan powder. Analysis revealed the presence of 0.41% Ti, 9.4% Zr, 10.2% Mg, and 3.61% Al.

C. The procedure of Example 2A was repeated, using instead 1.0 ml of 3% TiCl₄/toluene, to obtain 1.37 g of beige powder. Analysis revealed the presence of 0.35% Ti, 11.3% Zr, 12.5% Mg, and 3.74% Al.

D. The procedure of Example 2A was repeated, using instead 0.5 ml of 3% TiCl₄/toluene, to obtain 1.43 g of off-white powder. Analysis revealed the presence of 0.20% Ti, 10.6% Zr, 11.7% Mg, and 3.98% Al.

### Polymerization

To a one liter stainless steel reactor, containing 500 ml of hexane and 15 ml of 1-hexene, were added 500 standard cubic centimeter of H₂ (22 psi partial pressure). Triisobutylaluminum (0.52 mmol of 0.865 M heptane solution) was injected by syringe. A measured amount of the catalyst (as 0.60% slurry in mineral oil of the respective catalyst listed in the Table 1 below) was injected from a 50 ml bomb using ethylene pressure and about 20 ml of hexane. After polymerizing for 30 minutes at 85°, while adding ethylene on demand to keep the total pressure at 157 psi, the reaction was extinguished by injecting 2 ml of isopropanol. The collected polymer was allowed to air dry overnight before characterization. The catalyst productivities and pertinent polymer properties are as shown in the table below.

TABLE 1

| Catalyst | Yield | I₂₁ | I₂₁/I₅ | Mw/Mn |
|---|---|---|---|---|
| 2A | 13,700 | 5.99 | 15 | 11.7 |
| 2B | 12,000 | 7.25 | 19 | 11.7 |
| 2C | 10,500 | 7.81 | 21 | 11.8 |
| 2D | 8,950 | 6.04 | 23 | 12.6 |

Yield was in Kg PE/g catalyst hr/100 psi; and I₂₁ was in dg/min.

The Examples above reveal that polymer made using the catalysts of the invention have excellent flow properties and a broad MWD. In addition, the inventive catalysts produce polymer in high yield.

### Example 3

A number of experiments were carried out to produce a variety of polymerization catalyst precursors. Select precursors then were used to make polymerization procatalysts which in turn were used in polymerization experiments to produce polymers having excellent processability, flow characteristics and broad MWD.

### A. Preparation of Mg and Zr-containing precursor

A magnesium and zirconium-containing precursor was prepared via the following reaction:

1.9 Mg(OEt)₂+1.1MgCl₂.6EtOH+1.1 Zr(NEt₂)₄+0.1B(OEt)₃

[symbol]

Mg(OEt)₂ (5.44 g, 47.5 mmol), MgCl₂.6EtOH (10.22 g, 27.5 mmol) and Zr(NEt₂)₄ (10.44 g, 27.5 mmol) were mixed with 100 g of chlorobenzene in an 8 ounce bottle, and then triethyl borate (0.36 g, 2.5 mmol) was added. After stirring stirring for about 5 minutes at room temperature, the bottle was placed in a 76° oil bath and stirred for 90 minutes at 440 rpm whereupon all of the magnesium ethoxide granules appeared to have dissolved to produce an orange-brown translucent slurry. The cap was removed and a gentle flow of nitrogen passed over the reaction until about 8% of the solvent had evaporated. The mixture was allowed to stir and cool overnight then transferred to a glovebox and filtered. The solids were washed twice with chlorobenzene and twice with hexane then dried under -moving nitrogen. Obtained were 13.4 g of beige powder.

### B. Preparation of Mg Ti and Zr-containing precursor

A magnesium, titanium and zirconium-containing precursor was prepared via the following reaction:

3Mg(OEt)₂+0.42 ZrCl₄+0.68 Ti(OEt) ₄+0.15o-CH₃C₆H₄OH+391ROH

[symbol]

Mg(OEt)₂ (8.6 g, 75 mmol) was slurried into 100 gm of chlorobenzene (90 ml), in an 8 ounce bottle, o-cresol (0.40 g, 3.75 mmol) was added. After stirring for about one minute Ti(OEt)₄ (4.11 g, 95%, 17.1 mmol) and ZrCl₄ (2.42 g, 10.4 mmol) were added. The bottle was placed in an 85° oil bath, and then a mixture of Ethanol (4.5 ml, 3.53 g, 76.6 mmol) and Butanol (2.0 ml, 1.61 g, 21.3 mmol) was quickly added. After stirring for 30 minutes at 440 rpm the oil bath temperature was raised to about 100° C. Stirring was continued for another hour whereupon all of the granules of magnesium ethoxide appeared to have reacted. The cap was removed and a gentle flow of nitrogen passed over the reaction for 2 hours as about 8% of the solvent had evaporated. The reaction was transferred to a glovebox and filtered warm. The solids were washed once with chlorobenzene and twice with hexane then dried under moving nitrogen. Obtained were 10.6 g of white powder consisting predominately of granules about 8 to 12 microns in diameter with some finer material in the 2 to 5 micron range.

### C. Preparation of Mg, Ti(+3) and Zr-containing precursor

A magnesium, titanium (+3) and zirconium-containing precursor was prepared via the following reaction:

0.03 TiCl₄+0.015 MgBu₂ [symbol] A

2.98 Mg(OEt)₂+0.49 ZrC1₄ +A+0.40 Zr(OBu)₄+0.15 Zr(OEt)₄ +0.1 HOC₆H₄CO₂Me+3.8 EtOH

[symbol]

ZrCl₄ (2.85 g, 12.2 mmol), Zr(OEt)₄ (1.02 g, 3.75 mmol), Zr(OBu)₄ (4.40 g, 87.5%, 10.0 mmol), methyl salicylate (0.38 g, 2.5 mmol) and Ethanol (5.58 ml, 4.38 g, 95 mmol) were mixed with 20 g of chlorobenzene in a 2 ounce bottle, and then the mixture heated for about 10 minutes in a 95° C. oil bath to obtain a yellow solution. About 1.467 g of a solution of 9.84% TiCl4/chlorobenzene (0.76 mmol) was added to 40 g of chlorobenzene in an 8 ounce bottle, followed by 1.0 M Bu2Mg/heptane (0.374 ml, 0.267 g, 0.374 mmol) and the mixture allowed to stir an hour at about 60° C. To that slurry was added Mg(OEt)₂ (8.53 g, 74.5 mmol) followed by the yellow Zr solution rinsed in with 40 g of chlorobenzene. The bottle was placed in a 95° C. oil bath and stirred 3.5 hours at 440 rpm whereupon nearly all of the magnesium ethoxide granules appeared to have dissolved. The bottle cap was removed and a gentle stream of nitrogen passed over the reaction mixture for 90 minutes as about 9% of the solvent had evaporated. The stirring slurry was allowed to cool to about 30° C. then transferred to a glovebox and filtered. The solids were washed once with chlorobenzene and twice with hexane then dried under moving nitrogen. Obtained were 12.0 g of white powder composed predominately of translucent granules from 15 to 20 microns in diameter.

### D. Preparation of Mg, Hf and Zr-containing precursor

A magnesium, hafnium and zirconium-containing precursor was prepared via the following reaction:

3 Mg(OEt)₂+0.55 HfCl₄+0.40 Zr(OBu)₄+0.15 Ti(OEt)₄+0.1 HOC₆H₄CO₂OMe+3.8 EtOH

[symbol]

HfCl₄ (4.40 g, 13.75 mmol), Zr(OEt)₄ (1.02g, 3.75 mmol) and Zr(OBu)₄ (4.40 g, 87.5%, 10.0 mmol) were mixed with Ethanol (5.6 ml, 4.4 g, 95 mmol) in an 8 ounce bottle, and then methyl salicylate (0.38 g, 2.5 mmol) was added and the mixture allowed to stir overnight at room temperature to obtain a straw yellow solution. To the bottle was added 70 g of chlorobenzene followed by Mg(OEt)₂ (8.58 g, 75 mmol) followed by another 30 g of chlorobenzene. The bottle was placed in a 100° C. oil bath and stirred for 120 minutes at 440 rpm whereupon all of the magnesium ethoxide granules appeared to have dissolved. The bottle cap was removed and a gentle flow of nitrogen passed over the reaction until about 8% of the solvent had evaporated. The mixture was transferred to a glovebox and filtered warm. The solids were washed once with chlorobenzene and twice with hexane, and then dried under moving nitrogen. Obtained were 11.2 g of white powder composed predominately of white granules between 5 to 15 microns in diameter.

### E. Preparation of Mg, Hf, Ti and Zr-containing precursor

A magnesium, hafnium, titanium and zirconium-containing precursor was prepared via the following reaction:

3 Mg(OEt)₂+0.55 HfCl₄+0.40 Zr(OBu)₄+0.15 Ti(OEt)₄+0.1 HOC₆H₄CO₂OMe+3.8 EtOH

[symbol]

HfCl₄ (4.40 g, 13.75 mmol), Ti(OEt)₄ (0.90 g, 95%, 3.75 mmol) and Zr(OBu)₄ (4.40 g, 87.5%, 10.0 mmol) were mixed with Ethanol (5.6 ml, 4.4 g, 95 mmol) in an 8 ounce bottle, and then methyl salicylate (0.38 g, 2.5 mmol) was added. The mixture was stirred at about 60° C. for 45 minutes to obtain yellow solution. Another 70 g of chlorobenzene followed by Mg(OEt)₂ (8.58 g, 75 mmol) followed by another 30 g of chlorobenzene were added to the mixture. The bottle was placed in a 97° C. oil bath and stirred for 65 minutes at 440 rpm whereupon nearly all of the magnesium ethoxide granules appeared to have dissolved. A gentle flow of nitrogen was passed over the reaction for 2 hours as about 8% of the solvent evaporated. The slurry was allowed to stir and cool overnight then transferred to a glovebox and filtered. The solids were washed once with chlorobenzene and twice with hexane then dried under moving nitrogen. Obtained were 11.1 g of white powder composed predominately of nearly translucent granules of 5 to 15 microns in diameter.

### F. Preparation of Mg, Fe and Zr-containing precursor

A magnesium, iron and zirconium-containing precursor was prepared via the following reaction:

2.64 Mg(OEt)₂+0.21Mg(FeCl₄)₂.4EtOH+0.68Zr(OEt)₄ +0.2 1,2-C₆H₄(OH)(CHO)+2.8 EtOH

[symbol]

Mg(OEt)₂ (8.0, 69.8 mmol), Zr(OEt)₄ (4.64 g, 17.1 mmol) and Mg(FeCl₄)₂•4EtOH (3.1 g, 5.2 mmol) were mixed into 123 g of chlorobenzene an 8 ounce bottle, and then of salicylaldehyde (0.61 g, 5 mmol) was added. The bottle was placed in a 100° C. oil bath, and then Ethanol (4.1 g, 3.22 g, 70 mmol) was quickly added. The mixture was stirred for 140 minutes at 440 rpm to produce what had the appearance of a dark, red-brown, very cloudy solution. A gentle nitrogen flow was then passed over the reaction for 70 minutes to obtain a sticky, clumpy precipitate. The mixture was allowed to cool to about 28° C. whereupon the precipitate had become friable. The clumps were broken into pieces with the aid of a metal spatula and the reaction mixture then allowed to stir for 2 days in a 75° C. oil bath to obtain a homogeneous slurry. After stirring and cooling to room temperature, the solids were collected by filtration, and then washed once with chlorobenzene and twice with hexane, and then dried under moving nitrogen. Obtained were 10.6 g of peach colored powder containing some glassy particles all in the 15 micron diameter range.

### G. Preparation of My, Sn and Zr-containing precursor

A magnesium, tin and zirconium-containing precursor was prepared via the following reaction:

3 Mg(OEt)₂+0.54 SnCl₄+0.40Zr(OBu)₄+0.15 Zr(OEt)₄+0.1 HOC₆H₄CO₂OMe+3.8 EtOH

[symbol]

SnCl₄ (3.75 g, 14.4 mmol), Zr(OEt)₄ (1.07g, 3.94 mmol) and Zr(OBu)₄ (4.70 g, 87.5%, 10.68 mmol) were mixed with Ethanol (5.9 ml, 4.6 g, 0.1 mol) in an 8 ounce bottle, and then methyl salicylate (0.38 g, 2.5 mmol) was added. The mixture was allowed to stir overnight at room temperature to obtain a straw yellow solution. To that was added 70 g of chlorobenzene followed by Mg(OEt)₂ (9.12 g, 79.7 mmol) followed by another 30 g of chlorobenzene. The bottle was placed in a 95° C. oil bath and stirred for about 70 minutes at 440 rpm whereupon all of the magnesium ethoxide granules appeared to have dissolved to produce a translucent, homogeneous slurry. A gentle flow of nitrogen was passed over the slurry until about 7% of the solvent had evaporated. The slurry then was transferred to a glovebox and filtered warm. The solids were washed once with chlorobenzene and three times with hexane and dried under moving nitrogen. Obtained were 13.1 g of white powder.

### H. Preparation of Mg, V and Zr-containing precursor

A magnesium, vanadium and zirconium-containing precursor was prepared via the following reaction:

2.8 Mg(OEt)₂+0.55 VC1₄+0.55 Zr(OEt)₄+0.2 MgBr₂•4EtOH+4.2 EtOH

[symbol]

MgBr₂•4EtOH(1.84 g, 5.0 mmol), Mg(OEt)₂ (8.01 g, 70 mmol), Zr(OEt)₄ (3.73 g, 13.75 mmol) and a solution of 26.4% VC1₄ in chlorobenzene (10.04 g, 13.75 mmol) were mixed in an 8 ounce bottle, and then 108 g of chlorobenzene was added. The bottle was placed in a 100° C. oil bath and stirring started, and then Ethanol (6.16 ml, 4.84 g, 105 mmol) was quickly added. The mixture was allowed to stir for 63 minutes at 440 rpm whereupon all of the magnesium ethoxide granules appeared to have dissolved and a dark green, translucent slurry had been obtained. A gentle flow of nitrogen was passed over the reaction mixture until about 8% of the solvent had evaporated. The mixture was transferred to a glovebox and filtered warm. The solids were washed once with chlorobenzene and twice with hexane and dried under moving nitrogen. Obtained were 10.6 g of lime yellow powder consisting greater than 90% of granules in the 18 to 25 micron size range.

### Preparation of Polymerization Catalyst Precursors

The procedure set forth in Example 1 above was repeated except certain conditions were varied to produce a magnesium and zirconium containing precursor. The magnesium and zirconium containing precursors A, B, C, D, E, F or G from above (weight as shown in Table 1) were slurried in about 20 ml of hexane. The slurry was placed in an oil bath (temperature as shown in Table 1) to stir as 25% EADC/toluene (5.0 ml per gram of precursor) was added over about 2 minutes. After stirring for about 20 to 60 minutes (time as shown in Table 2 below), the mixture was filtered. The solids were washed twice with hexane and dried under moving nitrogen. The solids were slurried again in about 20 ml of hexane and returned to the oil bath. Over a period of about two minutes, 25% EADC/toluene (5.0 ml per gram of precursor) was added. After stirring for about 20 to 90 minutes (time as shown in Table 1) the mixture was filtered and the solids washed three times with hexane then dried under moving nitrogen. The yield of each procatalyst is shown in Table 2.

TABLE 2
Preparative conditions for polymerization procatalysts

| Precursor | weight | bath T | t1/t2 | Procat wt |
|---|---|---|---|---|
| # | gm | ° C. | min/min | gm |
| A | 2.11 | 25 | 60/90 | 1.84 |
| B | 2.10 | 25 | 25/25 | 1.81 |
| C | 2.40 | 70 | 45/65 | 1.77 |
| D | 10.0 | 75 | 45/45 | 9.08 |
| E | 2.38 | 25 | 60/20 | 2.19 |
| F* | 2.18 | 25 | 20/20 | 2.07 |
| G | 2.17 | 75 | 30/30 | 1.29 |

*The procatalyst from F was subjected to a further chlorination step consisting of stirring the powder for one hour at about 75° C. in 5.5 ml of a solution of 50% TiCl₄ in toluene. After filtration, the solids were washed five times with hexane, and then dried under moving nitrogen to obtain 2.48 g of brown powder.

### Slurry Polymerizations

The procatalysts prepared above were polymerized using the procedure outlined in Example 1 above. The loading of each procatalyst (in mg) is given in Table 3. The cocatalyst was about 0.3 to 1.0 mmol of either triethylaluminum (TEAL) or trilsobutylaluminum (TIBA) as indicated in Table 2. Hydrogen was adjusted to try to keep the I₂₁ below about 10 (between about 300 - 1400 standard cc as shown in Table 2). Polymerizations were carried out for a period of 30 minutes and the polymerization polymer yields were linearly extrapolated to one hour to obtain productivity as Kg polymer/g catalyst/100 psi ethylene/hour. Decay is presented as the decline in ethylene consumption over the last 20 minutes of the polymerization. The flow ratio is given as either I₂₁/I₅ or as MFR (values in parentheses).

TABLE 3
Results for hexane slurry polymerizations of ethylene

| Procatalyst | | | H2 | Producty | b.d. | I21 | | Decay/ |
|---|---|---|---|---|---|---|---|---|
| # | mg | Cocat | scc | kg/g/hr | g/cc | dg/min | I ratio | 20 min |
| A | 157 | TIBA | 1201 | 1.52 | 0.328 | 2.48 | 30 | 31% |
| B | 2.50 | TEAL | 643 | 25.5 | 0.278 | 13.8 | (66) | 50% |
| C | 20.0 | TIBA | 755 | 6.18 | 0.160 | 4.44 | 18 | 37% |
| D | 91.5 | TIBA | 1412 | 1.43 | 0.323 | 3.21 | 18 | 27% |
| E | 15.1 | TEAL | 293 | 9.22 | 0.241 | 3.35 | 14 | 29% |
| F | 3.89 | TEAL | 346 | 33.3 | 0.290 | 2.40 | (31) | 22% |
| G | 102 | TIBA | 1101 | 1.35 | 0.320 | 17.7 | (71) | 22% |

### Comparative Example

The procedure outlined in Example 1 above was repeated, except that the amounts of magnesium ethoxide, and the amounts of zirconium-containing compounds were altered so that the molar ratio of magnesium to zirconium was 3.6:1. The resulting precipitate was gelatinous and consequently, could not be used to make a polymerization procatalyst.

As can be seen from the above examples, a variety of mixed metal-containing precursors can be prepared, which in turn produce highly active polymerization procatalysts. The mixed metal precursors of the invention, when converted to polymerization procatalysts, produce polymers having excellent processability, flow characteristics and broad molecular weight distribution, and the catalysts have excellent catalyst decay. Using the guidelines provided herein, those skilled in the art are capable of tailoring polymerization procatalysts to provide a variety of catalyst decay rates and polymers having a variety of molecular weight distributions. The inventive examples also provide polymerization procatalysts that retain the excellent morphology of the precursor to thereby generate polymer having fewer fines, as well as a lower xylene solubles content.

While the invention has been described in detail with reference to particularly preferred embodiments, those skilled in the art appreciate that various modifications can be made without departing from the spirit and scope thereof. All documents referred to herein are incorporated by reference herein in their entirety.

1. A Ziegler-Natta catalyst composition useful for polymerization of olefins comprising:
A) a procatalyst composition comprising the reaction product of:
i) a compound comprising a mixed metal portion and alkoxide, phenoxide, halide, hydroxide, carboxylate or amide moieties, said mixed metal portion comprising a mixture of magnesium, zirconium and M- metals corresponding to the formula:
Mg_{y}ZrMₓ, wherein
M is Ti, V, Fe, Sn, Ni, Rh, Co, Cr, Mo, W, Hf or a mixture thereof,
x is a number greater than 0 and less than or equal to 2, and
y1+x is a number greater than 2.75 and less than or equal to 3.25;
ii) a halogenating agent; and
iii) an electron donor;
B) a cocatalyst; and
C) optionally a selectivity control agent.

2. A catalyst composition according to claim 1 wherein M is Ti, V, Fe, Sn, Hf, or a mixture thereof.

3. A catalyst composition according to claim 1 wherein M is Ti.

4. A catalyst composition according to claim 1 wherein the ratio x/y is from 0.01 to 0.5.

5. A catalyst composition according to claim 1 wherein the electron donor is an alkyl ester of an aromatic monocarboxylic- or dicarboxylic acid, or an aliphatic ether.

6. A catalyst composition according to claim 1 wherein the electron donor is methyl benzoate, ethyl benzoate, ethyl p-ethoxybenzoate, a 1 ,2-dialkoxybenzene, ethyl p-methylbenzoate, diethyl phthalate, dimethyl naphthalenedicarboxylate, diisobutylphthalate, diisopropyl terephthalate, diethyl ether, tetrahydrofuran, or a mixture thereof.

7. A catalyst composition according to claim 1 wherein the halogenating agent is selected from tetravalent titanium halides, SiCl₄, alkylaluminumhalides, or BC1₃.

8. A catalyst composition according to claim 1 wherein the halogenating agent is TiCl₄.

9. A catalyst composition according to claim 1 wherein the procatalyst comprises only ethoxide and chloride moieties.

10. A catalyst composition according to any one of claims 1-9 wherein the procatalyst is prepared by contacting a reaction mixture comprising magnesium-, zirconium- and M- metal- alkoxides, phenoxides, halides, hydroxides, carboxylates or amides in the presence of a clipping agent, and an alcohol, in an inert diluent, and recovering the solid procatalyst compound.

11. A catalyst composition according to claim 10 wherein the clipping agent is selected from: cresol, 3-methoxyphenol, 4-dimethylaminophenol, methylsalicylate, p-chlorophenol, formaldehyde, carbon dioxide, triethylborate, sulfur dioxide, aluminum triethoxide, carbonate dianions, bromide anions, ethyl carbonate anions, Si(OR)₄, R'Si(OR)₃ or P(OR)₃, wherein R and R' are Cₗ₋₁₀ hydrocarbyl.

12. A catalyst composition according to claim 10 wherein the inert diluent is a hydrocarbon or halohydrocarbon.

13. A catalyst composition according to claim 12 wherein the inert diluent is chlorobenzene.

14. A catalyst composition according to claim 10 wherein the reaction mixture is contacted at a temperature from 50 to 120 ° C.

15. A catalyst composition as claimed in claim 10 wherein the precursor is prepared by contacting a mixture comprising: (a) one or more magnesium alkoxides; (b) one or more zirconium alkoxides; and (c) one or more compounds selected from the group consisting of: TiCl₄, TiCl₃, VCl₄, FeCl₃, SnCl₄, HfCl₄, MnCl₂, Mg(FeCl₄)₂, SmCl₃.

16. A catalyst composition according to any one of claims 1-9 wherein the cocatalyst is an organoaluminum compound.

17. A catalyst composition according to claim 16 wherein the orgaonaluminum compound is a trialkylaluminum compound.

18. A catalyst composition according to any one of claims 1-9 comprising a selectivity control agent selected from alkyl esters of an aromatic monocarboxylic- or dicarboxylic acid, aliphatic ethers or organosilane compounds.

19. An olefin polymerization process comprising contacting an olefin with a catalyst composition according to any of claims 1-9.

20. An olefin polymerization process comprising contacting an olefin with a catalyst composition according to claim 10.

21. An olefin polymerization process comprising contacting an olefin with a catalyst composition according to claim 15.

22. An olefin polymerization process comprising contacting an olefin with a catalyst composition according to claim 16.

23. An olefin polymerization process comprising contacting an olefin with a catalyst composition according to claim 18.
